(19) United States
(12) Patent Application Publication
(10) Pub. No.: US 2025/0150524 A1
(43) Pub. Date: May 8, 2025

(54) HALO RING PHONE STAND

(71) Applicant: Oakridge Fabrication, Minnesota City, MN (US)

(72) Inventors: Dean DePestel, Minnesota City, MN (US); John Blomstrom, Minnesota City, MN (US)

(21) Appl. No.: 18/932,893

(22) Filed: Oct. 31, 2024

Related U.S. Application Data
(60) Provisional application No. 63/595,645, filed on Nov. 2, 2023.
(60) Provisional application No. 63/616,145, filed on Dec. 29, 2023.

(51) Int. Cl. H04M 1/04; F16M 11/04; F16M 11/10; F16M 11/20

(52) U.S. Cl. CPC H04M 1/04; F16M 11/041; F16M 11/105; F16M 11/2057

(57) ABSTRACT

A halo ring stand, comprising a base and a halo brake assembly, wherein the base and the halo brake assembly are rotatably coupled by a halo base standoff and a halo brake assembly base standoff and rotatable about a first axis. A halo ring receivable within a cavity of the halo brake assembly, wherein the halo ring is rotatable about a second axis, different from the first axis, through the cavity. A device clamp assembly coupled to the halo ring and configured to receive and secure an electronic device, wherein the device clamp assembly includes two or more holding brackets that are extendable and retractable to secure the electronic device, wherein the device clamp assembly is rotatable about a third axis, different from the first axis and second axis, about the halo ring.

### CROSS-REFERENCE TO RELATED APPLICATION

The present disclosure claims the benefit of U.S. Provisional Application No. 63/595,645, filed Nov. 2, 2023, and U.S. Provisional Application No. 63/616,145, filed Dec. 29, 2023, which are hereby fully incorporated by reference in their entirety.

### TECHNICAL FIELD

The present disclosure generally relates to systems and methods for holding or securing electronic devices. In particular, the present disclosure relates to holding or securing mobile devices and to enable multi-directional orientation of the electronic device for view by a user.

### BACKGROUND

As technology develops, particularly with electronic devices, such as mobile phones, tablets, and other portable devices, necessities or preferences have been developed in people's work and personal life for easier incorporation and operation. Currently, portable electronic devices have numerous functions, and can be used for watching videos, listening to music, phone calls, messaging, gaming, and other various forms of entertainment and communication. However, depending on the need of the user, these electronic devices come in various shapes, sizes, and configurations. Moreover, the location in which these devices are used may change quite frequently depending on the schedule of the user and type of use (e.g., at home, in the car, in an office, outdoors, etc.). As the daily or weekly time of electronic device use increases, including any work, study and entertainment use of the electronic devices (e.g., bending over a table, viewing the device on a countertop, such as a kitchen countertop or family room table, holding the device in the hand of a user, operations during a motor vehicle, etc.), the user may find it difficult or frustrating to keep an accurate view of the electronic device or keep the device secured in a single location, without falling or breaking.

Some existing solutions are available, for example, various electronic device holders. However, these existing holders can be too small to receive the device, be too bulky to be placed in a desired location, or lack the portability necessary to be beneficial to the user, Current portable device stands only provide limited adjustability and customization features. Many portable device stands are uncomfortable to use, for example because the mobile device is held in an uncomfortable position. Other portable devices may not be constructed such that adequate support for the device may be established (e.g., in certain positions, use of the device may result in the entire system falling over or collapsing). In some examples, the stand may not allow the user to adjust or rotate the stand sufficiently, whether vertically or horizontally, and if so, the extent to which the stand may be adjusted can be significantly limited. In some examples. The stand may be limited in rotatability, which would limit the extent to which the device may be viewed at alternative angles, such as if the base would be left stationary. Thus, limiting axis rotation (either relative to the base or the electronic device) for the user to utilize. In some examples, the structure of the stand may be relatively simple in configuration, which may prevent the stand from extending or rotating beyond a single direction or length. Moreover, the use of some of these example stands can be relatively inconvenient and may not have the necessary adaptability preferred by a user.

Thus, it is necessary and desirable to provide a more efficient and effective electronic device stand that enables independently adjustable, multi-directional rotatable components to enable adaptable rotatability such that a 360-degree or near 360-degree view of the electronic device may be realized by a user.

### SUMMARY

Non-limiting examples of the present disclosure provide a halo ring stand, comprising a base and a halo brake assembly, wherein the base and the halo brake assembly are rotatably coupled by a halo base standoff and a halo brake assembly base standoff and rotatable about a first virtual axis from the base. A halo ring receivable within a cavity of the halo brake assembly, wherein the halo ring is rotatable about a second horizontal axis through the ring stand, different from the first axis, through the cavity. A device clamp assembly coupled to the halo ring and configured to receive and secure an electronic device, wherein the device clamp assembly includes two or more holding brackets that are extendable and retractable to secure the electronic device, wherein the device clamp assembly is rotatable about a third holder axis, different from the first axis and second axis, about the halo ring.

In examples, a friction coefficient between the halo ring and the cavity within the halo brake assembly provides friction onto the halo ring to prevent rotation of the halo ring when in idle use and enables rotation about the second axis upon exertion of an external force from a user.

In examples, a plurality of selectively retractable or affixed teeth within the cavity are incorporated to retain the halo ring in a fixed position when in idle use and enable rotation of the halo ring about the second axis upon exertion of an external force by a user.

In examples, the first, second, and third axis include a set of multi-directional axes that may be independently rotatable, configured to provide a 360° field of view of the device to a user.

In examples, the base includes one or more support elements, wherein the support elements include at least one of a pad, adhesive, or suction cup.

In examples, the halo ring is a hollow halo ring comprising a center cavity, wherein the diameter and width of the halo ring are just sufficient enough to be received within the cavity of the halo brake assembly, wherein the dimensions between the halo ring and the center cavity provide a friction coefficient that prevents rotation of the halo ring when in idle use and enables rotation about the second axis upon exertion of an external force from a user.

In examples, the halo ring is a hollow halo ring and includes a display coupled within, wherein the display is coupled to the halo brake assembly via one or more securing portions.

In examples, the display includes at least one area for branding, advertisement, acknowledgement, or otherwise exposure of information on either or both sides of opposing wall faces of the display.

In examples, the display is constructed of a polymer, glass, or metal material.

In examples, the halo ring stand is configured to secure relatively smaller, pocket-sized electronic devices within the device clamp assembly.

In examples, the halo ring stand is configured to secure relatively larger, tablet sized electronic devices within the device clamp assembly.

Non-limiting examples of the present disclosure provide method of use for a halo ring stand, comprising expanding two or more holding brackets of a device clamp assembly. Placing a device between the two or more holding brackets and retracting the holding brackets to secure the device within the device clamp assembly. Rotating a halo brake assembly, coupled to a base, wherein the rotation of the rotation of the halo brake assembly is about a first axis relative to the stationary base. Rotating a halo ring, at least partially coupled within a cavity of the halo brake assembly, wherein the halo ring is rotatable through the cavity about a second axis, different from the first axis and rotating the device claim assembly about a third axis, different from the first axis and second axis.

In examples, the method may include creating a friction coefficient between the halo ring and the cavity within the halo brake assembly providing a friction onto the halo ring to prevent rotation of the halo ring when in idle use and enables rotation about the second axis upon exertion of an external force from a user.

In examples, the method may include including a plurality of selectively retractable or affixed teeth within the cavity that are incorporated to retain the halo ring in a fixed position when in idle use and enable rotation of the halo ring about the second axis upon exertion of an external force by a user.

In examples, the method may include the first, second, and third axis including a set of multi-directional axis that may be independently rotatable, configured to provide a 360° field of view of the device to a user.

In examples, the method may include a hollowed center cavity within the halo ring, wherein the diameter and width of the halo ring are just sufficient enough to be received within the cavity of the halo brake assembly, wherein the dimensions between the halo ring and the center cavity provide a friction coefficient that prevents rotation of the halo ring when in idle use and enables rotation about the second axis upon exertion of an external force from a user.

In examples, the method may include including a display coupled within the hollow halo ring, wherein the display is coupled to the halo brake assembly via one or more securing portions.

In examples, the method may include including at least one area for branding, advertisement, acknowledgement, or otherwise exposure of information on either or both sides of opposing wall faces of the display.

In examples, the method may include securing a relatively smaller, pocket-sized electronic device within the device clamp assembly.

In examples, the method may include securing a relatively larger, tablet sized electronic device within the device clamp assembly.

The summary above is not intended to describe each illustrated example or every implementation of the present disclosure. The figures and the detailed description that follow more particularly exemplify these examples.

### BRIEF DESCRIPTION OF THE DRAWINGS

Subject matter hereof may be more thoroughly understood in consideration of the following detailed description of various examples in connection with the accompanying figures, in which:

FIG. 1 depicts a front side perspective view of a halo ring stand, according to according to examples.

FIG. 2 depicts an opposing front side perspective side view of the halo ring stand of FIG. 1, according to examples.

FIG. 3 depicts a back side perspective side view of the halo ring stand of FIGS. 1 and 2, according to examples.

FIG. 4 depicts a side cross-sectional view of a halo ring tablet stand, according to examples.

FIG. 5 depicts an opposing side view of the halo ring tablet stand, according to examples.

FIG. 6 depicts top views of the halo ring tablet stand, according to examples.

FIG. 7 depicts a front facing view of the halo ring tablet stand, according to examples.

FIG. 8 depicts a cross sectional view of a brake assembly according to examples.

FIG. 9 depicts a block diagram of a method of use for a halo ring stand, according to embodiments.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter of the present disclosure.

### DETAILED DESCRIPTION OF THE DRAWINGS

Embodiments of the present disclosure are generally related to systems and methods for holding or securing electronic devices. In particular, the present disclosure relates to holding or securing mobile devices and to enable multi-directional orientation of the electronic device for view by a user.

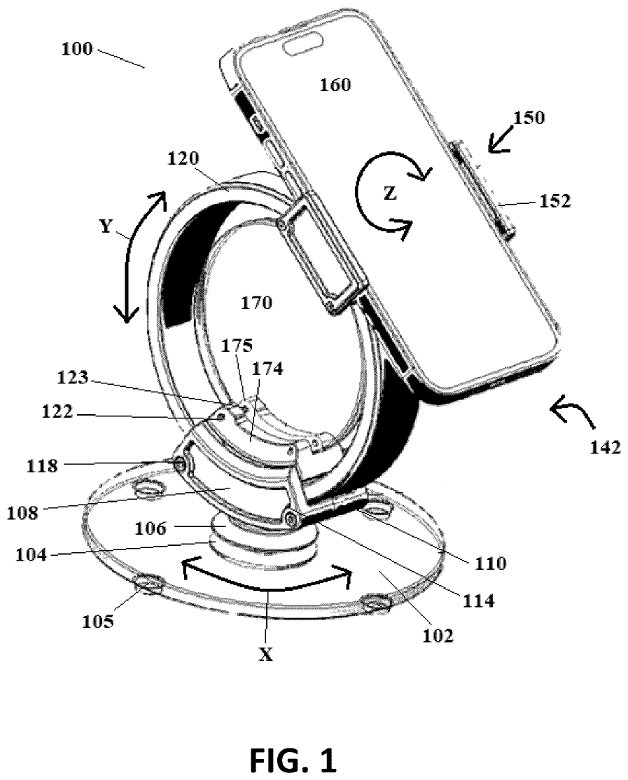

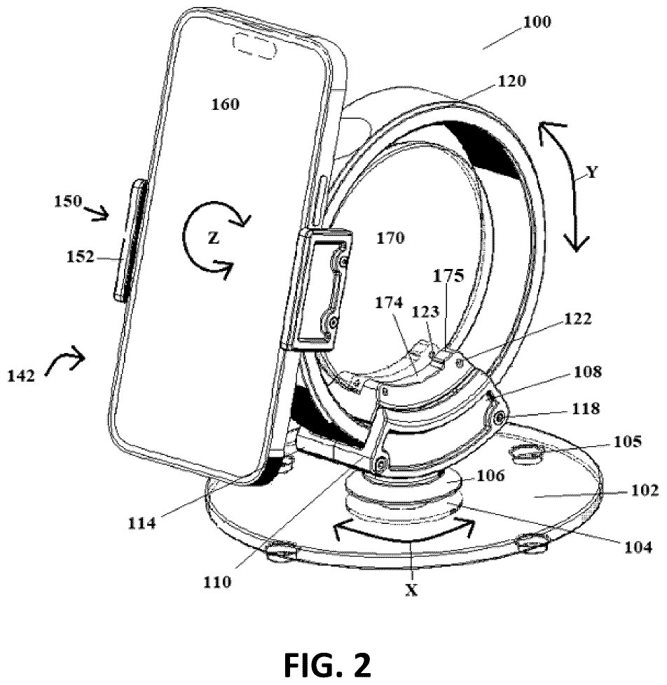

FIGS. 1 and 2 depict a front perspective cross-sectional side view and an opposing side view of a halo ring stand for electronic devices, according to examples. In examples, halo ring stand 100 may include a halo base 102 and a halo lower base standoff 104, wherein halo lower base standoff 104 is fixedly coupled to a bottom surface of the halo base 102. In examples, halo lower base standoff 104 may be configured to be rotatably coupled to a halo brake assembly base standoff 106 of halo brake assembly 108, in which the halo lower base standoff 104 and halo brake assembly standoff 106 may be coupled between the base 102. The halo lower base standoff 104 providing additional support for the halo ring stand 100 with the one or more pads 105 (described in greater detail below). In examples, the halo lower base standoff 104 and the halo brake assembly base standoff 106 may be rotatably and fixedly coupled together with a halo retention screw (not shown), wherein the retention screw may be coupled through about the middle or about centralized within halo base standoff 104 and halo brake assembly base standoff 106. In examples, retention screw may be configured to align the outer or inner edges of halo lower base standoff 104 and halo brake assembly base standoff 106.

In examples, the rotatable combination between the halo lower base standoff 104 and halo brake assembly base standoff 106 may be rotatable about axis ‘X.’ In examples halo lower brake standoff 106, halo brake assembly 108, and halo ring 120 may be rotatable about an axis X relative to halo base 102 and halo lower base standoff 104, which may remain stationary. In examples, rotatability may be a full or about 360° relative to halo base 102. In examples, halo base 102 and halo lower base standoff 104 may remain stationarily secured to a surface, such as the ground, table, countertop, etc. In examples, the halo ring stand 100, particularly, halo base 102 may remain secured or stationary with a surface by way of one or more pads 105. In examples, one or more O-rings (not shown) may be coupled within or in-between halo lower base standoff 104 and halo brake assembly base standoff 106 to facilitate or more effectively allow rotation about axis ‘X’ upon an exertion of force by a user. In examples, the one or more O-rings may be a type of washer, such as an Ultra High Molecular Weight (UHMW) or plastic washer. One or more pads 105 may be positioned on the opposing or bottom side of the halo base 102 relative to the halo lower base standoff 104. In examples, one or more pads 105 may be manufactured of a sticky material to provide stability and securement to a surface. In examples, one or more pads 105 may be manufactured of a tacky material (e.g., adhesive, tape, etc.) such that the halo ring stand 100 may adhere to a surface, providing stability and securement. In examples, the tacky material used may allow the halo ring stand 100 to be removably coupled with the surface. In examples, one or more pads may include a suction cup-like mechanism, which may secure the halo ring stand 100 to a surface. In examples, one or more pads 105, including suction cup mechanism, may be pressed onto the surface to provide a vacuum seal between the pads 105 and the surface. Upon removal or relocation of the halo ring stand 100, a user may move, adjust, pinch, or otherwise disrupt the vacuum seal between the suction cup and the surface for easy removal or relocation. In embodiments, one or more pads may be constructed of a polymer (e.g., plastic), silica, or other type of material, in which may enable the halo ring stand 100 to rest on a surface. In examples, one or more pads 105 may prevent or otherwise reduce any knicks, starches, scrapes, or other types of damage that may occur to a surface or other elements during use, placement, and removal of halo ring stand 100. One or more pads may also prevent or reduce any damage that halo base 102 may sustain. It should be understood that, while four pads 105 are depicted and are circular in shape, alternative shapes, configurations, and quantities are contemplated.

In examples, coupled to halo brake assembly base standoff 106 may include halo brake assembly 108. Halo brake assembly 108 may include a first cavity and a second cavity, wherein the halo brake assembly 108 may be hollow therethrough between the first and second portions of the break assembly 110, 114. In examples, the hollow cavity may be rectangular in shape. In examples, the hollow cavity may be constructed of an arc or curved shape configured to receive a rotatable halo ring 120. In examples, the halo brake assembly may be configured to be coupled together and separated by at least two pieces, such as a first portion 110, and a second portion 114 via securing units 118. In examples, halo ring 120 may be configured to be inserted into and within the cavity of the halo brake assembly 108, wherein the first and second portions 110, 114 may be secured together, encompassing the halo ring 120 within the cavity. In examples, securing units 118 may be any form of a screw, bolt, punch pin, etc. such that the halo brake assembly 108 securely houses and stands the halo ring 120 atop the base standoff 104, which is coupled to the halo base 102. In examples, securing units may include one or more securing units insertable and couplable within one or more insertions set to receive the one or more securing units. In examples, 4 securing units may be used to secure the first and second portions 110, 114 (e.g., two securing units on each portion side).

In examples, first portion 110 coupled with second portion 114 may be coupled with a securing display 174. In examples, securing display 174 may be constructed of a single piece. Thus, in examples, the halo brake assembly 108 may be constructed of two pieces that secure in place the halo ring 120, coupled with the securing display 174, and thus, may secure display 170 simultaneously. In embodiments, these depicted elements may be removably coupled individually from halo ring stand 100. Thus, in examples, halo brake assembly 108 being constructed of more than two pieces and may secure in place halo ring 120 and display 170 individually.

In examples, securing portion 174 may be constructed of a single piece. In examples, securing elements 122 may insertable into a plurality of openings 123, such that halo brake assembly 108 and may be further secured in place and secure the halo ring 120 in place. In examples, securing elements 122 may insertable into a plurality of openings 123, such that, should securing portion 174 be constructed of individual pieces, securing elements 122 may be further configured to secure the display 170. In examples, securing elements 122 may be any form of a screw, bolt, punch pin, etc. such that, at least in part, securing portion 174 holds and secure the display 170 within the hollow halo ring 120. In examples, securing portion 174 may be coupled to first portion 110 and second portion 116 by way of additional or alternative coupling mechanism as described herein (e.g., securing elements, glue, mechanical integration/configuration, etc.). In examples, display 170 may be removably coupled from within the hollow halo ring 120. It should be understood that, while a circular display is depicted, alternative shapes, sizes and configurations are contemplated. In examples, display 170 may be manufactured of any suitable material, for example, polymer (e.g., plastic), glass, metal (e.g., steel, aluminum, etc.), etc.

In examples, display 170 may be configured to include at least one section, on either or both sides of opposing wall faces of display 170, may include an area for branding, advertisement, acknowledgement, or otherwise exposure of information. In examples, the at least one section may be an indentation among either or both sides of opposing wall faces, protuberances therefrom, a smooth surface for etching or drawing, or otherwise configured to receive the branding, advertisement, acknowledgement, or otherwise exposure of information (e.g., via a sticker, embossing, etching, laser engraving, drawn, etc.). In examples, the at least one section may be configured to permanently integrated into or within display 170.

In examples, while halo brake assembly 108 may securely lock the halo ring 120 into place, halo ring 120 may be selectively rotatable about axis ‘Y.’ In examples, portions of the halo ring 120 may be received within the cavity of halo break assembly 108. In examples, repositioning of an electronic device clamp assembly 150, coupled to halo ring 120 (described in greater detail below), may be achieved by rotating the halo ring 120 about axis ‘Y.’ In examples, electronic device clamp assembly 150 coupled to halo ring 120 may be rotated, or “walked,” between a forward-facing position 142 (as shown) to an opposing facing position (not show), wherein portions of the halo ring are selectively rotated by a user and received from second cavity and forced out of first cavity between the first and second portions 110, 114. Such selective repositioning enables rotation of the halo ring 120 between positions. In examples, the opposite may occur, wherein electronic device clamp assembly 150 coupled to halo ring 120 may be rotated between the opposing facing position to forward facing position 142, wherein portions of the halo ring are selectively rotated by a user and received from first cavity and forced out of second cavity. In examples, halo ring 120 may be rotatable about a circumference between each end of the halo brake assembly 108 (i.e., between the location of the first and second cavities), wherein a component of the clamp assembly 150 may be securely flush between each end.

In examples, halo brake assembly 108 may be configured with a variety of types of locking or pressurized mechanisms that may hold or otherwise retain halo ring 120 (e.g., facing the electronic device clamp assembly 150 in a desired direction for the user about axis ‘Y’) within the cavity. In examples, a plurality of selectively retractable or affixed elements (e.g., a plurality of teeth, notches, or rubber pads) may be used within cavity of halo brake assembly 108 to retain halo 120 in a fixed position. In examples, upon an external force exerted by the user, the plurality of selectively retractable or affixed elements may be configured to allow halo ring 120 to rotate about axis ‘Y.” In examples, when the external force ceases, the plurality of selectively retractable or affixed elements may grasp or otherwise cause friction onto halo ring 120, which may prevent halo ring 120 from rotating any further. In examples, at least a portion of the securing portion 174 may be selectively pivoted or an external force by a user to enable a push point location 175. In examples, push point 175 may cause the brake to release. Upon repositioning of the halo ring 120, the securing portion may automatically or manually reposition the securing portion 174 and it be returned to its original locked position, thus resecuring the halo ring. In examples, support elements can be knurled, or have a plurality of teeth, notches, or ridges, to improve retention of the halo ring 120 within the cavity. In examples, it should be understood that the more support elements within the halo brake assembly, additional precision can be achieved such that a greater number of positions of electronic device clamp assembly 150 may be retained about axis ‘Y.’ It should be understood that the intention is not to limit the claimed inventions to the particular embodiments described and shown by way of example in the drawings. On the contrary, the intention is to cover all modifications, equivalents, and alternatives falling within the spirit and scope of the subject matter as defined by the claims. In examples, the halo ring 120 may be configured to be positioned within the cavity of halo brake assembly 108 such that a high enough friction coefficient is present such that, when the halo ring 120 is idle and no external force is being exerted, the halo ring 120 remains stationary in the current position and does not move or otherwise rotate on its own, as described above. However, in examples, the friction coefficient is such that, when the user wants to reposition the electronic device clamp assembly 150 (e.g., about the ‘Y’ axis), the friction is light enough to allow the rotation from exertion of the external force but tight enough to prevent movement or rotation without an external force.

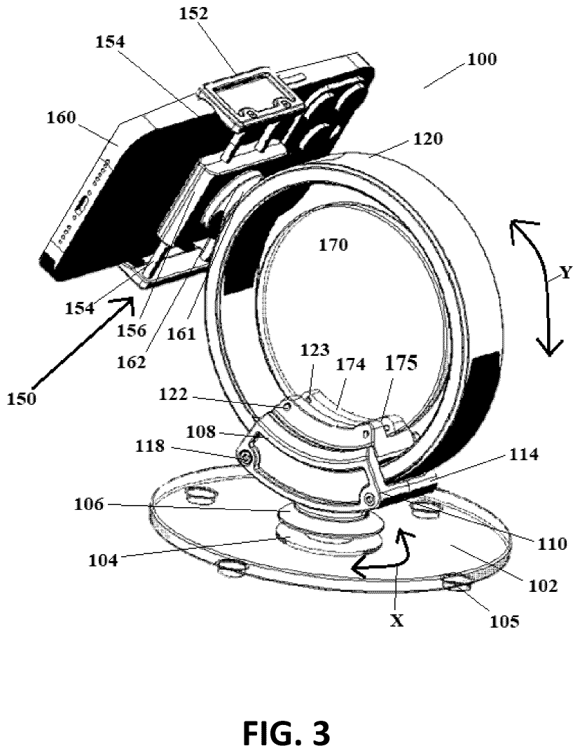

With additional reference to FIG. 3, FIG. 3 depicts a back side perspective view of the halo ring stand of FIGS. 1 and 2, according to examples. A support structure, such as electronic device clamp assembly 150, may be mounted or otherwise coupled to the rotatable halo ring 120. In examples, electronic device clamp assembly 150 may be coupled to halo ring 120 via a metric ball-nose spring plunger 161 coupled with halo ring 120 and enable rotatable communication with a transition gripper mount 162, wherein the transition gripper mount 162 is coupled to the back side of electronic device clamp assembly 150. In examples, transition gripper mount 162 may be coupled to a resting base 156 for an electronic device 160.

In examples, electronic device clamp assembly 150 may include at least a first and second holding bracket 152, a plurality of adjustable arms 154, and resting base 156 for securing electronic device 160. In examples, holding brackets 152 may by simultaneously expanded and retracted to fit or otherwise secured in between an electronic device 160 of varying sizes (e.g., pocket sized electronic devices, such as, a mobile device, cell phone, or other wireless device). In examples, expansion and retraction may be adjustable by extending adjustable arms 154 outward from the resting base 156 or pushing extendable arms 154 within the resting base 156, wherein the adjustable arms 154 are coupled to the holding brackets 152 and slidably coupled within the resting base 156. In examples, the holding brackets 152 may include a spring-loaded mechanism to automatically secure the electronic device, following manual expansion of the holding brackets 152 by the user.

In examples, electronic device clamp assembly 150 may be coupled via rotatable communication between metric ball-nose spring plunger 161 and transition gripper mount 162, wherein electronic device clamp assembly 150 may be selectively rotatable about axis ‘Z,’ rotatable relative to metric ball-nose spring plunger 161 and halo ring 120. In examples, rotation of electronic device clamp assembly 150, coupled to halo ring 120, may be achieved by manually rotating the electronic device clamp assembly 150 by a user about axis ‘Z.’ In examples, rotation of electronic device clamp assembly 150 may enable a 360° rotation of an electronic device when secured in electronic device clamp assembly 150 (e.g., enabling an electronic device to rotate between a vertical position, horizontal position, and anywhere in-between).

Thus, in combination, halo ring stand 100 may enable a user to interact or view an electronic device, secured by electronic device clamp assembly 150, with a or at least near 360° view in three-dimensional space. The multi-directional configuration allows individual control for the user to adjust accessibility between axis ‘X,” axis ‘Y,’ and axis ‘Z.’ Thus, complete and precise control may be provided to the user and may accommodate any or at least the majority of activities and positions in which the user may wish to view or use the electronic device 160.

In examples, halo ring 120 may be configured to be a hollow ring. Halo ring 120 may have a diameter and width up to or about the diameter and width of the first and second cavities between the first and second portions 110, 114 (and within the cavity of the halo brake assembly 108). In examples, the width and diameter of the halo ring 120 and first and second cavities are compatible such that the underlying friction coefficient, described above, may be achieved. In examples, a display portion 170 may be positioned within the hollow space of the halo ring 120. In examples, display portion 170 may be fixedly or removably coupled within at least a portion of the securing portion 174. In examples, securing elements 123 may include any form of a screw, bolt, punch pin, etc. such that the display 170 may be securely housed within the hollow halo ring 120 via the plurality of openings 123.

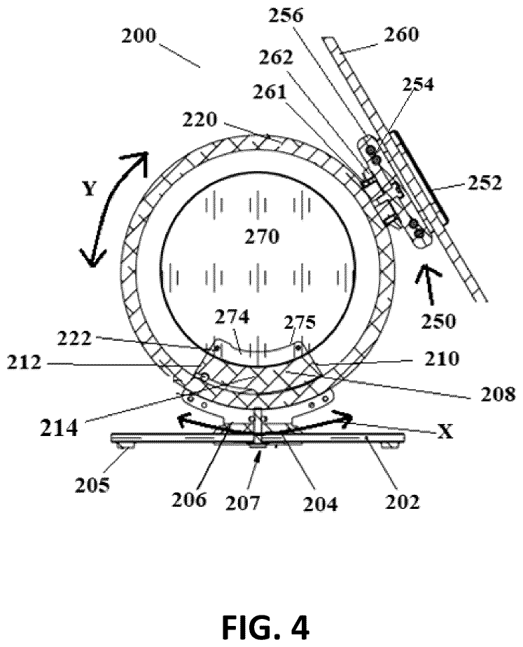

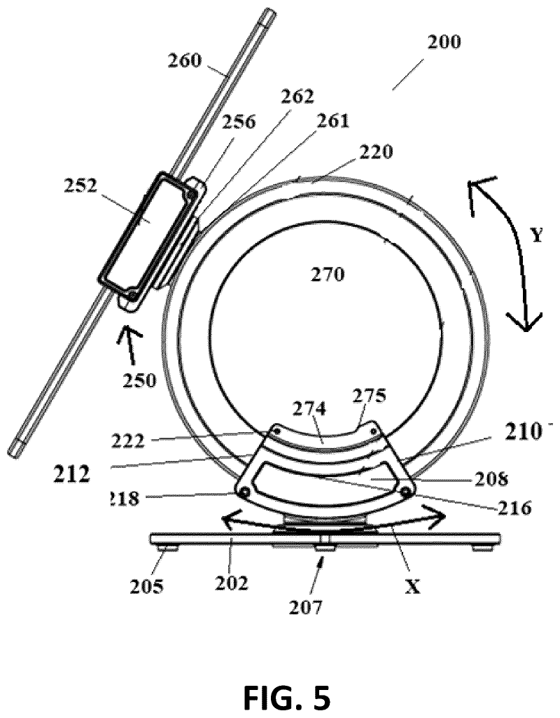

FIGS. 4 and 5 depict a first cross-sectional side view and an opposing side view, respectively, of a halo ring stand for electronic devices, according to examples. In examples, halo ring stand 200 may be configured to accommodate relatively larger electronic devices, relative to, for example, in pocket electronics (e.g., tablets, multi-functional laptops, or other various devices). In examples, halo ring stand 200 may include a halo base 202 and a base standoff 204, wherein base standoff 204 is fixedly coupled to a top surface of the halo base 202. In examples, base standoff 204 may be configured to be rotatably coupled to a halo brake assembly base standoff 206 of halo brake assembly 208. In examples, the halo base standoff 204 and the halo brake assembly base standoff 206 may rotatably and fixedly coupled together with a halo retention screw 207, wherein the retention screw may be coupled through about the middle or about centralized within halo base standoff 204 and halo brake assembly base standoff 206. In examples, retention screw may be configured to align the out or inner edges of halo base standoff 204 and halo brake assembly base standoff 206.

In examples, the rotatable combination between the halo base standoff 204 and halo brake assembly base standoff 206 may be rotatable about axis ‘X.’ In examples halo brake standoff 206, halo brake assembly 208, and halo ring 220 may be rotatable about an axis X relative to halo base 202 and base standoff 204, which may remain stationary. In examples, rotatability may be a full or about 360° relative to halo base 202. In examples, one or more O-rings (not shown) or previously described one or more washers may be coupled within or in-between base standoff 204 and halo brake assembly base standoff 206 to facilitate or more effectively allow rotation about axis ‘X’ upon an exertion of force by a user. In examples, halo base 202 and base standoff 204 may remain stationarily secured to a surface, such as the ground, table, countertop, etc. In examples, the halo ring stand 200, particularly, halo base 202 may remain secured or stationary with a surface by way of one or more pads 205. One or more pads 205 may be positioned on the opposing or bottom side of the halo base 202 relative to the base standoff 204. In examples, one or more pads 205 may be manufactured of a sticky material to provide stability and securement to a surface. In examples, one or more pads 205 may be manufactured of a tacky material (e.g., adhesive, tape, etc.) such that the halo ring stand 200 may adhere to a surface, providing stability and securement. In examples, the tacky material used may allow the halo ring stand 200 to be removably coupled with the surface. In examples, one or more pads may include a suction cup-like mechanism, which may secure the halo ring stand 200 to a surface. In examples, one or more pads 205, including suction cup mechanism, may be pressed onto the surface to provide a vacuum seal between the pads 205 and the surface. Upon removal or relocation of the halo ring stand 200, a user may move, adjust, pinch, or otherwise disrupt the vacuum seal between the suction cup and the surface for easy removal or relocation. In embodiments, one or more pads may be constructed of a polymer (e.g., plastic), silica, or other type of material, in which may enable the halo ring stand 200 to rest on a surface. In examples, one or more pads 205 may prevent or otherwise reduce any knicks, starches, scrapes, or other types of damage that may occur to a surface or other elements during use, placement, and removal of halo ring stand 200. One or more pads may also prevent or reduce any damage that halo base 202 may sustain. It should be understood that, while four pads 205 are depicted and are circular in shape, alternative shapes, configurations, and quantities are contemplated.

In examples, coupled to halo brake assembly base standoff 206 may include halo brake assembly 208. Halo brake assembly 208 may include a first cavity 210 and a second cavity 212, wherein the halo brake assembly 108 may be hollow therethrough between the first and second portions 214, 216. In examples, the hollow cavity may be rectangular in shape. In examples, the hollow cavity may be constructed of an arc or curved shape configured to receive a rotatable halo ring 220. In examples, the halo brake assembly may be configured to the coupled together and separated by at least two pieces, such as a first portion 214, and a second portion 216 via securing units 218. In examples, halo ring 220 may be configured to be inserted into and within the cavity of the halo brake assembly 208, wherein the first and second portions 214, 216 may be secured together, encompassing the halo ring 220. In examples, securing units 218 may be any form of a screw, bolt, punch pin, etc. such that the halo brake assembly 208 securely houses and stands the halo ring 220 atop the base standoff 204, which is coupled to the halo base 202.

In examples, securing display 274 may be constructed of a single piece. Thus, in examples, the halo brake assembly 208 may be constructed of two pieces that secure in place the halo ring 220 and, an additional securing display coupled to the first and second portions 114, 116 that may secure display 270 simultaneously (as depicted). In examples, first portion and second portion 214, 216, and securing display 274 may be constructed of individual pieces, which may be removably coupled individually from halo ring stand 200. Thus, in examples, halo brake assembly 208 being constructed of more than two pieces and may secure in place halo ring 220 and display 270 individually.

In examples, securing elements 222 may insertable into a plurality of openings 223, such that display 270 may be secured in place within the halo ring 220 and easily removed or replaced. In examples, securing elements 222 may insertable into a plurality of openings 223, such that, securing elements 222 may be further configured to secure the display 270. In examples, securing elements 222 may be any form of a screw, bolt, punch pin, etc. such that, at least in part, securing portion 274 holds and secures the display 270 within the hollow halo ring 220. In examples, securing portion 274 may be coupled to first portion 214 and second portion 216 by way of additional or alternative coupling mechanism as described herein (e.g., securing elements, glue, mechanical integration/configuration, etc.). In examples, display 270 may be removably coupled from within the hollow halo ring 220. It should be understood that, while a circular display is depicted, alternative shapes, sizes and configurations are contemplated. In examples, display 270 may be manufactured of any suitable material, for example, polymer (e.g., plastic), glass, metal (e.g., steel, aluminum, etc.), etc.

In examples, display 270 may be configured to include at least one section, on either or both sides of opposing wall faces of display 270, may include an area for branding, advertisement, acknowledgement, or otherwise exposure of information. In examples, the at least one section may be an indentation among either or both sides of opposing wall faces, protuberances therefrom, a smooth surface for etching or drawing, or otherwise configured to receive the branding, advertisement, acknowledgement, or otherwise exposure of information (e.g., via a sticker, embossing, etching, laser engraving, drawn, etc.). In examples, the at least one section may be configured to permanently integrated into or within display 270.

In examples, while halo brake assembly 208 may securely lock the halo ring 220 into place, halo ring 220 may be selectively rotatable about axis ‘Y.’ In examples, portions of the halo ring 220 may be received within the cavity of halo break assembly. In examples, repositioning of an electronic device clamp assembly 250, coupled to halo ring 220 (described in greater detail below), may be achieved by rotating the halo ring 220 about axis ‘Y.’ In examples, electronic device clamp assembly 250 coupled to halo ring 220 may be rotated between a forward-facing position to an opposing facing position, wherein portions of the halo ring are selectively rotated by a user and received from second cavity 212 and forced out of first cavity 214. Such selective repositioning enables rotation of the halo ring 220 between positions. In examples, the opposite may occur, wherein electronic device clamp assembly 250 coupled to halo ring 220 may be rotated between the opposing facing position to forward facing position, wherein portions of the halo ring are selectively rotated by a user and received from first cavity 210 and forced through second cavity 212. In examples, halo ring 220 may be rotatable about a circumference between each end of the halo brake assembly 208 (i.e., between the location of the first and second cavities 210, 212), wherein a component of the clamp assembly 250 may be securely flush between each end.

In examples, halo brake assembly 208 may be configured with a variety of types of locking or pressurized mechanisms that may hold or otherwise retain halo ring 220 (e.g., facing the electronic device clamp assembly 250 in a desired direction for the user about axis ‘Y’) within the cavity. In examples, a plurality of selectively retractable or affixed elements (e.g., a plurality of teeth or notches) may be used within cavity of halo brake assembly 208 to retain halo ring 220 in a fixed position. In examples, upon an external force exerted by the user, the plurality of selectively retractable or affixed elements may be configured to allow halo ring 220 to rotate about axis ‘Y.” In examples, when the external force ceases, the plurality of selectively retractable or affixed elements may grasp or otherwise cause friction onto halo ring 220, which may prevent halo ring 220 from rotating any further. In examples, support elements can be knurled, or have a plurality of teeth, notches, or ridges, to improve retention of the halo ring 220 within the cavity. In examples, it should be understood that the more support elements within the halo brake assembly, additional precision can be achieved such that a greater number of positions of electronic device clamp assembly 250 may be retained about axis ‘Y.’ It should be understood that the intention is not to limit the claimed inventions to the particular embodiments described and shown by way of example in the drawings. On the contrary, the intention is to cover all modifications, equivalents, and alternatives falling within the spirit and scope of the subject matter as defined by the claims. In examples, the halo ring 220 may be configured to be positioned within the cavity of halo brake assembly 208 such that a high enough friction coefficient is present such that, when the halo ring 220 is idle and no external force is being exerted, the halo ring 220 remains stationary in the current position and does not move or otherwise rotate on its own, as described above. However, in examples, the friction coefficient is such that, when the user wants to reposition the electronic device clamp assembly 250 (e.g., about the ‘Y’ axis), the friction is light enough to allow the rotation from exertion of the external force but tight enough to prevent movement or rotation without an external force. In examples, the halo brake assembly may be configured with a press and release mechanism, such that locking into position of the halo ring 220 may be achieved. In examples, at least in part, coupled to securing portion 274, a press/release or rotatable mechanism 275 may be implemented to release and secure the halo ring 220 in position, in examples, a user may press or hold down the mechanism 275, rotate the halo ring 220 to a desired position for the user, and repress or release the mechanism to secure the halo ring 220 in the new position. In examples. Mechanism 275 may be configured to be rotated or pivoted outwardly, and back inwardly (manually or automatic) thus releasing and resecuring halo ring 220.

In examples, a support structure, such as electronic device clamp assembly 250, may be mounted or otherwise coupled to the rotatable halo ring 220. In examples, electronic device clamp assembly 250 may be coupled to halo ring 220 via a metric ball-nose spring plunger 261 coupled with halo ring 220 and enable rotatable communication with a transition gripper mount 262, wherein the transition gripper mount 262 is coupled to the back side of electronic device clamp assembly 250. In examples, transition gripper mount 262 may be coupled to a resting base 256 for an electronic device 260.

In examples, electronic device clamp assembly 250 may include at least a first and second holding bracket 252, a plurality of adjustable arms 254, and resting base 256 for securing electronic device 260. In examples, holding brackets 252 may by simultaneously expanded and retracted to fit or otherwise secured in between an electronic device 260 of varying sizes (e.g., pocket sized electronic devices, such as, a mobile device, cell phone, tablets or other wireless device). In examples, expansion and retraction may be adjustable by extending, e.g., spring loaded, adjustable arms 254 outward from the resting base 256 or pushing extendable arms 254 within the resting base 256, wherein the adjustable arms 254 are coupled to the holding brackets 252 and slidably coupled within the resting base 256.

In examples, electronic device clamp assembly 250 may be coupled via rotatable communication between metric ball-nose spring plunger 261 and transition gripper 262, wherein electronic device clamp assembly 250 may be selectively rotatable about axis ‘Z,’ rotatable relative to metric ball-nose spring plunger 261 and halo ring 220. In examples, rotation of electronic device clamp assembly 250, coupled to halo ring 220, may be achieved by manually rotating the electronic device clamp assembly 250 by a user about axis ‘Z.’ In examples, rotation of electronic device clamp assembly 250 may enable a 360° rotation of an electronic device when secured in electronic device clamp assembly 250 (e.g., enabling an electronic device to rotate between a vertical position, horizontal position, and anywhere in-between).

Thus, in combination, halo ring stand 200 may enable a user to interact or view an electronic device, secured by electronic device clamp assembly 250, with a or at least near 360° view in three-dimensional space. The multi-directional configuration allows individual control for the user to adjust accessibility between axis ‘X,” axis ‘Y,’ and axis ‘Z.’ Thus, complete and precise control may be provided to the user and may accommodate any or at least the majority of activities and positions in which the user may wish to view or use the electronic device 260.

In examples, halo ring 220 may be configured to be a hollow ring. Halo ring 220 may have a diameter and width up to or about the diameter and width of the first and second cavities 210, 212 (and within the cavity of the halo brake assembly 208). In examples, the width and diameter of the halo ring 220 and first and second cavities 210, 212 are compatible such that the underlying friction coefficient, described above, may be achieved. In examples, a display portion 270 may be positioned within the hollow space of the halo ring 220. In examples, display portion 270 may be fixedly or removably coupled between the securing display securing display 274. Securing display 274 and may be removably coupled together to adjust and affix display 270 via one or more. In examples, securing elements may include any form of a screw, bolt, punch pin, etc. such that the display 270 may be securely housed within the hollow halo ring 220. In examples, securing elements may include securing elements 222. In example, a serious of four securing elements 222 spaced evenly and parallel among each side of securing display 274. However, alternative securing measures are contemplated.

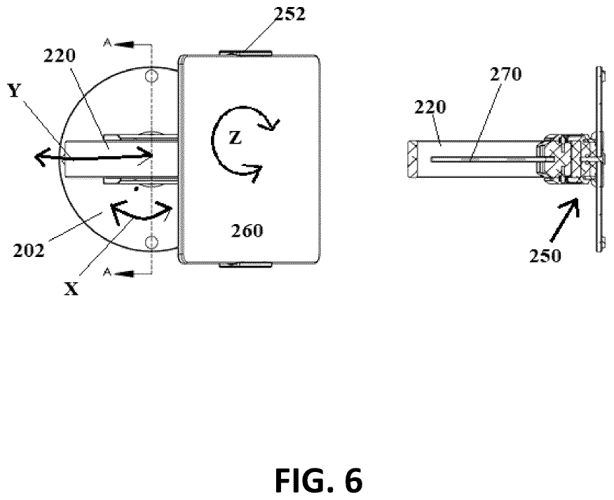

FIG. 6 depicts the electronic device stand 200 according to FIGS. 4 and 5 in alternative positions, which may have multiple, independent rotatable axis.

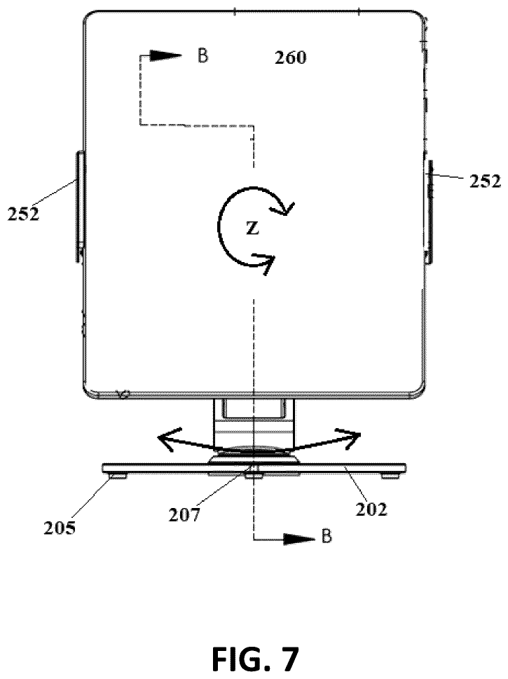

FIG. 7 depicts a forward-facing view of the electronic device stand 200, according to examples. It is to be understood that, similarly with reference to FIGS. 1-3, electronic device stand 200 may include the same or similar components. However, electronic device stand 200 and the components in which it may be constructed may be configured to be relatively larger, relative to the counterpart electronic device stand 100. In examples, electronic device stand 200 may be configured to accommodate and secure relatively larger electronic devices, other than, for example, mobile phones. In examples, halo brake assembly 208 may be configured to receive relatively larger devices, such as tablets, notebooks, computers, etc. without the electronic device 260 slipping from the security of device clamp assembly 250 or tipping over the electronic device stand 200 (i.e., regardless of what direction the electronic device 260 is facing or position about the ‘X,’ ‘Y,’ or ‘Z’ axis.

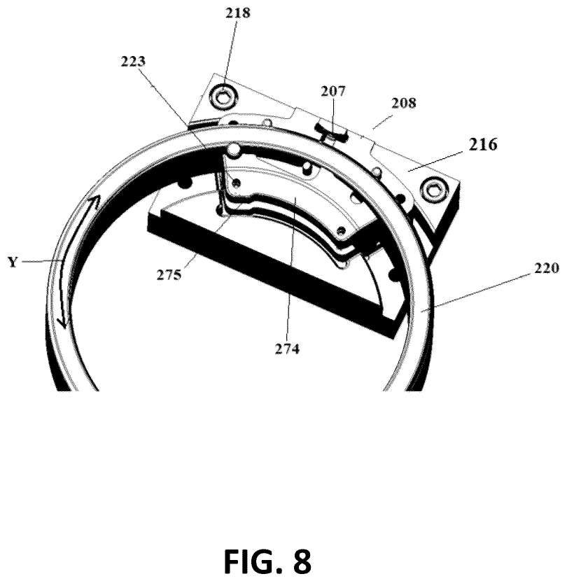

FIG. 8 depicts a cross sectional view of a brake assembly, according to examples. While an example description has been provided for ease of description relative to FIGS. 4-7, the functionality may be applied to various electronic device holders, such as those represented in FIGS. 1-3. In examples, smaller or larger components may be utilized to facilitate the independent, multi-directional axis rotation as described herein. In examples, halo ring 220 may be secured our otherwise coupled within the cavity between the first portion and second portion 216 of halo brake assembly 208.

In examples, the halo ring may be rotated about the “Y” axis as previously described above. In examples, the internal structure with cavity between the first and second portions 216 may include a plurality of selectively retractable or affixed elements (e.g., a plurality of teeth, notches, or rubber pads) that may be used within the cavity of halo brake assembly 208 to retain halo 220 in a fixed position. In examples, upon an external force exerted by the user, the plurality of selectively retractable or affixed elements may be configured to allow halo ring 220 to rotate about axis ‘Y.” In examples, when the external force ceases, the plurality of selectively retractable or affixed elements may grasp or otherwise cause friction onto halo ring 220, which may prevent halo ring 220 from rotating any further.

In examples, at least a portion of the securing portion 274 may be selectively pivoted or an external force by a user to enable a push point location 275. In examples, push point 275 may cause the brake to release. Upon repositioning of the halo ring 220, the securing portion may automatically or manually reposition the securing portion 274 and it be returned to its original locked position, thus resecuring the halo ring. In examples, support elements can be knurled, or have a plurality of teeth, notches, or ridges, to improve retention of the halo ring 220 within the cavity. In examples, it should be understood that the more support elements within the halo brake assembly, additional precision can be achieved such that a greater number of positions of electronic device clamp assembly 150 may be retained about axis ‘Y.’ It should be understood that the intention is not to limit the claimed inventions to the particular embodiments described and shown by way of example in the drawings. On the contrary, the intention is to cover all modifications, equivalents, and alternatives falling within the spirit and scope of the subject matter as defined by the claims.

In examples, the halo base standoff 204 and the halo brake assembly base standoff 206 may be rotatably and fixedly coupled together with a halo retention screw 207, wherein the retention screw may be coupled through about the middle or about centralized within halo base standoff 204 and halo brake assembly base standoff 206. In examples, retention screw may be configured to align the out or inner edges of halo base standoff 204 and halo brake assembly base standoff 206. In examples, halo retention screw 207 may provide a secure coupling between the halo brake assembly base standoff 206 and the halo base standoff 204, wherein the base 202 may be coupled therebetween. In examples, the halo base standoff 204 may be positioned on the underside of the base 202 for additional securement of the halo ring 200 (e.g., including the one or more pads 205).

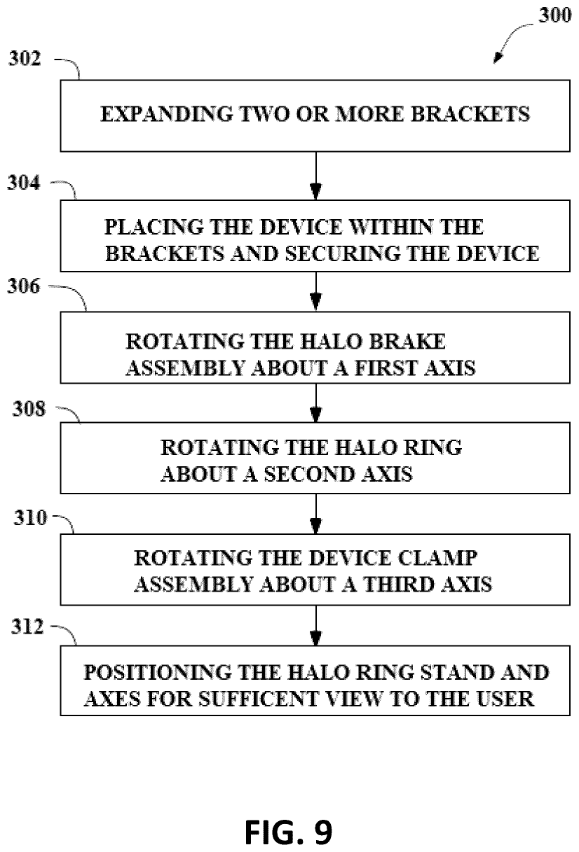

FIG. 9 depicts a block diagram of a method of use for a halo ring stand, according to embodiments. At 302 a method of use for a halo ring stand may include, if necessary for ease of receiving an electronic device, expanding two or more holding brackets of a device clamp assembly. At 304, a user may place a device, such as an electronic device (e.g., mobile device, cell phone, tablet, etc.) between the two or more holding brackets, supported by a resting base, and retract the holding brackets to secure the device within the device clamp assembly. At 306, a halo brake assembly, coupled to a base, may be rotatable, wherein the rotation of the halo brake assembly is about a first axis relative to the stationary base. At 308 the halo ring, couple at least partially coupled within a cavity of the halo brake assembly, may be rotatable, wherein the halo ring is rotatable through the cavity about a second axis, different from the first axis. At 310, the device clamp assembly may be rotatable about a third axis, different from the first axis and second axis, wherein variations between vertical, horizontal, and anywhere in-between rotations of the device may be achieved. In examples, a friction coefficient between the halo ring and the cavity within the halo brake assembly provides friction onto the halo ring to prevent rotation of the halo ring when in idle use and enables rotation about the second axis upon exertion of an external force from a user. In examples, a plurality of selectively retractable or affixed teeth within the cavity are incorporated to retain the halo ring in a fixed position when in idle use and enable rotation of the halo ring about the second axis upon exertion of an external force by a user. At 312, a user has positioned the halo ring stand and rotated at least one of the first, second and third axis such that view of the electronic device is in a sufficient location and in sufficient view determined by the user.

It should be understood that the individual operations used in the methods of the present teachings may be performed in any order and/or simultaneously, as long as the teaching remains operable. Furthermore, it should be understood that the apparatus and methods of the present teachings can include any number, or all, of the described examples, as long as the teaching remains operable.

Various examples of systems, devices, and methods have been described herein. These examples are given only by way of example and are not intended to limit the scope of the claimed inventions. It should be appreciated, moreover, that the various features of the examples that have been described may be combined in various ways to produce numerous additional examples. Moreover, while various materials, dimensions, shapes, configurations and locations, etc. have been described for use with disclosed examples, others besides those disclosed may be utilized without exceeding the scope of this disclosure.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood by persons of ordinary skill in the art. Moreover, elements described with respect to one example can be implemented in other examples even when not described in such examples unless otherwise noted.

Although a dependent claim may refer in the claims to a specific combination with one or more other claims, other examples can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A halo ring stand, comprising:
a base and a halo brake assembly, wherein the base and the halo brake assembly are rotatably coupled by a halo base standoff and a halo brake assembly base standoff and rotatable about a first axis;
a halo ring receivable within a cavity of the halo brake assembly, wherein the halo ring is rotatable about a second axis, different from the first axis, passable through the cavity; and
a device clamp assembly coupled to the halo ring and configured to receive and secure an electronic device, wherein the device clamp assembly includes two or more holding brackets that are extendable and retractable to secure the electronic device, wherein the device clamp assembly is rotatable about a third axis, different from the first axis and second axis, about the halo ring.

2. The halo ring stand of claim 1, wherein a friction coefficient between the halo ring and the cavity within the halo brake assembly provides friction onto the halo ring to prevent rotation of the halo ring when in idle use and enables rotation about the second axis upon exertion of an external force from a user.

3. The halo ring stand of claim 1, wherein a plurality of selectively retractable or affixed teeth within the cavity are incorporated to retain the halo ring in a fixed position when in idle use and enable rotation of the halo ring about the second axis upon exertion of an external force by a user.

4. The halo ring stand of claim 1, wherein the first, second, and third axis include a set of multi-directional axis that may be independently rotatable, configured to provide a 360° field of view of the device to a user.

5. The halo ring stand of claim 1, wherein the base includes one or more support elements, wherein the support elements include at least one of a pad, adhesive, or suction cup.

6. The halo ring stand of claim 1, wherein the halo ring is a hollow halo ring comprising a center cavity, wherein the diameter and width of the halo ring are just sufficient enough to be received within the cavity of the halo brake assembly, wherein the dimensions between the halo ring and the center cavity provide a friction coefficient that prevents rotation of the halo ring when in idle use and enables rotation about the second axis upon exertion of an external force from a user.

7. The halo ring stand of claim 1, wherein the halo ring is a hollow halo ring and includes a display coupled within, wherein the display is coupled to the halo brake assembly via one or more securing portions.

8. The halo ring stand of claim 7, wherein the display includes at least one area for branding, advertisement, acknowledgement, or otherwise exposure of information on either or both sides of opposing wall faces of the display.

9. The halo ring stand of claim 7, wherein the display is constructed of a polymer, glass, or metal material.

10. The halo ring stand of claim 7, wherein the halo ring stand is configured to secure relatively smaller, pocket-sized electronic devices within the device clamp assembly.

11. The halo ring stand of claim 7, wherein the halo ring stand is configured to secure relatively larger, tablet sized electronic devices within the device clamp assembly.

12. A method of use for a halo ring stand, comprising:
expanding two or more holding brackets of a device clamp assembly;
placing a device between the two or more holding brackets and retracting the holding brackets to secure the device within the device clamp assembly;
rotating a halo brake assembly, coupled to a base, wherein the rotation of the rotation of the halo brake assembly is about a first axis relative the stationary base;
rotating a halo ring, at least partially coupled within a cavity of the halo brake assembly, wherein the halo ring is rotatable through the cavity about a second axis, different from the first axis; and
rotating the device claim assembly about a third axis, different from the first axis and second axis.

13. The method of use for a halo ring of claim 12, further comprising creating a friction coefficient between the halo ring and the cavity within the halo brake assembly providing a friction onto the halo ring to prevent rotation of the halo ring when in idle use and enables rotation about the second axis upon exertion of an external force from a user.

14. The method of use for a halo ring stand of claim 12, further comprising including a plurality of selectively retractable or affixed teeth within the cavity are incorporated to retain the halo ring in a fixed position when in idle use and enable rotation of the halo ring about the second axis upon exertion of an external force by a user.

15. The method of use for a halo ring stand of claim 12, further comprising the first, second, and third axis including a set of multi-directional axis that may be independently rotatable, configured to provide a 360° field of view of the device to a user.

16. The method of use for a halo ring stand of claim 12, further comprising a hollowed center cavity within the halo ring, wherein the diameter and width of the halo ring are just sufficient enough be received within the cavity of the halo brake assembly, wherein the dimensions between the halo ring and the center cavity provide a friction coefficient that prevents rotation of the halo ring when in idle use and enables rotation about the second axis upon exertion of an external force from a user.

17. The method of use for a halo ring stand of claim 12, further comprising including a display coupled within the hollow halo ring, wherein the display is coupled to the halo brake assembly via one or more securing portions.

18. The method of use for a halo ring stand of claim 17, further comprising including at least one area for branding, advertisement, acknowledgement, or otherwise exposure of information on either or both sides of opposing wall faces of the display.

19. The method of use for a halo ring stand of claim 12, further comprising securing a relatively smaller, pocket-sized electronic device within the device clamp assembly.

20. The method of use for a halo ring stand of claim 12, further comprising securing a relatively larger, tablet sized electronic device within the device clamp assembly.
